(19) United States
(12) Patent Application Publication
(10) Pub. No.: US 2022/0229692 A1
(43) Pub. Date: Jul. 21, 2022

(54) METHOD AND DEVICE FOR DATA TASK SCHEDULING, STORAGE MEDIUM, AND SCHEDULING TOOL

(71) Applicant: CHANGXIN MEMORY TECHNOLOGIES, INC, Hefei City (CN)

(72) Inventors: Hui ZHANG, Hefei (CN); Hanxu GAO, Hefei (CN)

(21) Appl. No.: 17/460,431

(22) Filed: Aug. 30, 2021

Related U.S. Application Data
(63) Continuation of application No. PCT/CN2021/103455, filed on Jun. 30, 2021.

(30) Foreign Application Priority Data
Jan. 15, 2021 (CN) 202110055086.8

(51) Int. Cl. G06F 9/48

(52) U.S. Cl. CPC G06F 9/4818; G06F 9/485

(57) ABSTRACT

A method and device for data task scheduling, a storage medium, and a scheduling tool are involved. The method includes: acquiring a data task to be executed at present which is configured with a task relationship; in response to that the data task to be executed at present satisfies a preset condition, ranking, according to the task relationship, the data task to be executed at present to create a data task queue; acquiring a load situation of a plurality of node servers, to determine a target node server; and sending, based on the data task queue, the data task to be executed at present to the target node server for processing.

### CROSS-REFERENCE TO RELATED APPLICATIONS

This application is a continuation of International Application No. PCT/CN2021/103455, filed on Jun. 30, 2021, which claims priority to Chinese Patent Application No. 202110055086.8, filed to the China National Intellectual Property Administration on Jan. 15, 2021 and entitled “Method and Device for data task scheduling, Storage Medium, and Scheduling Tool”. The contents of International Application No. PCT/CN2021/103455 and Chinese Patent Application No. 202110055086.8 are incorporated herein by reference in their entireties.

### BACKGROUND

In order to meet increasing service requirements and solve the problem of poor processing capability, data Extract-Transform-Load (ETL) tool software is needed.

At present, mainstream ETL tools software usually arrange a scheduling sequence of multiple tasks manually. When hundreds or thousands of tasks need to be scheduled, the tasks are networked, and it is difficult to figure out their relationships manually.

Moreover, a single server is limited in processing capability, and thus load problems are usually solved in a distributed manner conventionally in case of excessive load. In the distributed manner, tasks in a complex relationship cannot be distributed and executed well.

### SUMMARY

The disclosure relates to the technical field of data management, and particularly to a method for data task scheduling, a scheduling tool and a non-transitory computer-readable storage medium.

In a first aspect, provided is method for data task scheduling, including: acquiring a data task to be executed at present which is configured with a task relationship; in response to that the data task to be executed at present satisfies a preset condition, ranking, according to the task relationship, the data task to be executed at present to create a data task queue; acquiring a load situation of a plurality of node servers, to determine a target node server; and sending, based on the data task queue, the data task to be executed at present to the target node server for processing.

In a second aspect, provided is a scheduling tool including a memory and a processor, wherein the memory stores a computer program capable of running in the processor, and the processor is configured to execute the computer program to implement following: acquiring a data task to be executed at present which is configured with a task relationship; in response to that the data task to be executed at present satisfies a preset condition, ranking, according to the task relationship, the data task to be executed at present to create a data task queue; acquiring a load situation of a plurality of node servers, to determine a target node server; and sending, based on the data task queue, the data task to be executed at present to the target node server for processing.

In a third aspect, provided is a non-transitory computer-readable storage medium having stored thereon a computer program which, when executed by a processor, implements following: acquiring a data task to be executed at present which is configured with a task relationship; in response to that the data task to be executed at present satisfies a preset condition, ranking, according to the task relationship, the data task to be executed at present to create a data task queue; acquiring a load situation of a plurality of node servers, to determine a target node server; and sending, based on the data task queue, the data task to be executed at present to the target node server for processing

### BRIEF DESCRIPTION OF THE DRAWINGS

In order to describe the technical solutions in the embodiments of the disclosure or in the related art more clearly, the drawings needing to be used in descriptions about the embodiments or the related art will be simply introduced below. It is apparent that the drawings described below are only some embodiments of the disclosure. Other drawings may further be obtained by those of ordinary skill in the art according to these drawings without creative work.

FIG. 1 illustrates a flowchart of a method for data task scheduling according to an embodiment.

FIG. 2 illustrates a flowchart of a method for data task scheduling according to a particular embodiment.

FIG. 3 illustrates a schematic diagram of a data task queue management algorithm according to an embodiment.

FIG. 4 illustrates a schematic diagram of a data management, extraction, cleaning, and distribution flow according to an embodiment.

FIG. 5 illustrates a structural block diagram of a device for data task scheduling according to an embodiment.

FIG. 6 illustrates a structural block diagram of a device for data task scheduling according to a particular embodiment.

### DESCRIPTIONS ABOUT THE REFERENCE SIGNS

10: device for data task scheduling; 11: task relationship management module; 12: task scheduling module; 13: cluster management module; 111: task relationship configuration unit; 112: task execution unit; 113: monitoring and early warning unit; 1131: real-time monitoring unit; 1132: early warning management unit; 121: task receiving unit; 122: data queue management unit; 123: message collection unit; 124: load condition calculation unit; 125: data distribution management unit; and 131: cluster management unit.

### DETAILED DESCRIPTION

For easily understanding the disclosure, description will be made more comprehensively below with reference to the related drawings. The drawings illustrate preferred embodiments of the disclosure. However, the disclosure may be implemented in various forms and is not limited to the embodiments described herein. Instead, these embodiments are provided to make the contents disclosed in the disclosure understood more thoroughly and comprehensively.

It is necessary to provide a method and device for data task scheduling, a storage medium, and a scheduling tool, to solve the problems in the conventional art that it is difficult to figure out a relationship between tasks and tasks in a complex relationship cannot be distributed and executed well.

In the method and device for data task scheduling, the storage medium and the scheduling tool, each data task is configured with a corresponding task relationship. That is to say, there is also a corresponding task relationship for the data task to be executed at present. The data task to be executed at present is ranked according to the task relationship to create the data task queue, in response to that the data task to be executed at present satisfies the preset condition, so that relationships between data tasks to be executed at present can be figured out automatically even if complex. The execution efficiency of the data tasks is improved effectively, data quality problems caused by manual intervention are solved, and the integrity of data is ensured. Moreover, the target node server is determined according to the load situation of each node server, and the data task to be executed at present is sent to the target node server for processing based on the data task queue. The case that some node servers are affected in terms of processing speed and even cannot perform processing due to excessive load and resources are wasted due to relatively low load of some node servers may be avoided. The load of all node servers is relatively balanced, and data tasks in complex relationships may also be distributed and executed well. According to the method and device for data task scheduling, the storage medium and the scheduling tool, a scheduling tool may bear more scheduled tasks, shorten the task execution time and achieve a scaling-out capability.

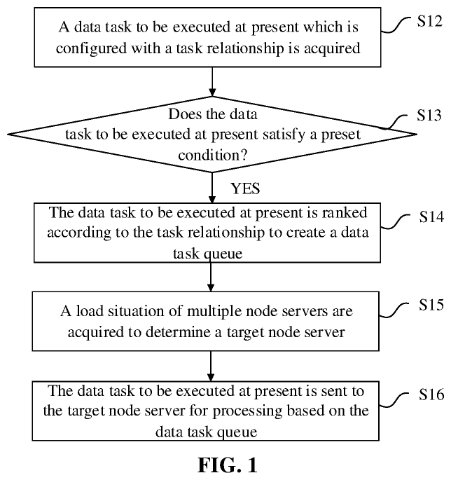

As illustrated FIG. 1, a method for data task scheduling is provided in an embodiment. Description is made with an example that the method is applied to a terminal. It can be understood that the method may also be applied to a server, or may be applied to a system including the terminal and the server and implemented by interaction between the terminal and the server. In the embodiment, the method includes the following operations.

In S12, a data task to be executed at present which is configured with a task relationship is acquired.

Specifically, the method for data task scheduling may be applied to ETL task distribution management, task processing of business reports, processing of machine table production data, or other scenes. The data task may be a task in these application scenes. Each data task may be correspondingly configured with a task relationship such as forward dependency, a priority, and an execution cycle in advance. An operator may start data task scheduling through input device such as a keyboard, a mouse, a touch screen, and a button, this data task being a data task to be executed at present, thereby acquiring the data task to be executed at present among data tasks. Alternatively, scheduling of the data task to be executed at present may be triggered automatically at a preset time, and scheduling of corresponding data tasks may be triggered at different moments, thereby acquiring the data task to be executed at present among the data tasks. The data task to be executed at present may be a single data task or a combination of multiple data tasks. There is also a corresponding task relationship for the data task to be executed at present.

In S13, whether the data task to be executed at present satisfies a preset condition is determined.

Specifically, the preset condition may be set according to the task relationship corresponding to the data task to be executed at present. Whether the data task to be executed at present satisfies the preset condition is determined. If YES, S14 is executed. If NOT, whether the data task to be executed at present satisfies the preset condition may be continued to be determined, and S14 is executed when the preset condition is satisfied. Alternatively, a next data task to be executed may be taken as a data task to be executed at present, and whether the next data task to be executed satisfies a corresponding preset condition is determined. If the next data task to be executed satisfies the corresponding preset condition, S14 is executed. Namely next task scheduling that has not been executed is cyclically determined.

In S14, the data task to be executed at present is ranked according to the task relationship to create a data task queue.

Specifically, when the data task to be executed at present is a single data task, the data task queue includes only one data task. When the data task to be executed at present is a combination of multiple data tasks, the multiple data tasks to be executed at present may be ranked using a data task queue management algorithm according to a task relationship between the data tasks, thereby obtaining the data task queue.

In S15, a load situation of multiple node servers is acquired to determine a target node server.

Specifically, an operating system monitor (OSWatch) may be configured for each node server. The OSWatch may be configured to monitor a central processing unit (CPU), memory, input/output (I/O), process, etc., of the corresponding node server. The load situation of each node server may further be acquired from the corresponding OSWatch, so as to determine the target node server. For example, the node server with lower load is determined as the target node server.

In S16, based on the data task queue, the data task to be executed at present is sent to the target node server for processing.

Specifically, a node server with excessive load may be distributed with no data task, and data tasks may be distributed to a node server with a relatively low load, i.e., the target node server, thereby avoiding the situation that some node servers are affected in terms of processing speed and even cannot perform processing due to excessive load and resources are wasted due to relatively low load of some node server. The data task to be executed at present is sent to the target node server based on the data task queue, so that the target node server may sequentially process each data task in the queue according to a sequence in the data task queue, and the task relationship corresponding to the data task to be executed at present is satisfied.

In the method for data task scheduling, each data task is configured with a corresponding task relationship. That is to say, there is also a corresponding task relationship for the data task to be executed at present. The data task to be executed at present is ranked according to the task relationship to create the data task queue, in response to that the data task to be executed at present satisfies the preset condition, so that relationships between data tasks to be executed at present can be figured out automatically even if complex. The execution efficiency of the data tasks is improved effectively, data quality problems caused by manual intervention are solved, and the integrity of data is ensured. Moreover, the target node server is determined according to the load situation of each node server, and the data task to be executed at present is sent to the target node server for processing based on the data task queue. The case that some node servers are affected in terms of processing speed and even cannot perform processing due to excessive load and resources are wasted due to relatively low load of some node servers may be avoided. The load of all node servers is relatively balanced, and data tasks in complex relationships may also be distributed and executed well. According to the method for data task scheduling, a scheduling tool may bear more scheduled tasks, shorten the task execution time and achieve a scaling-out capability.

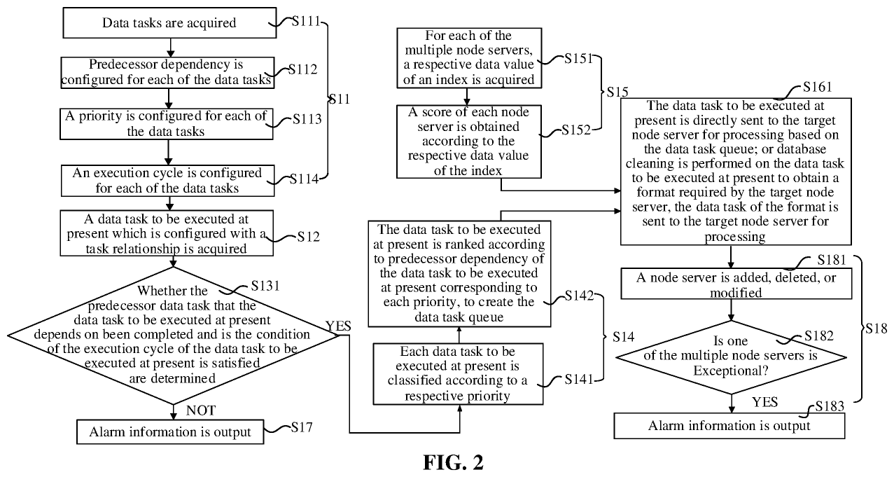

In an embodiment, as illustrated in FIG. 2, before the operation in S12 that the data task to be executed at present is acquired, the method for data task scheduling further includes the following operations. In S11, a task relationship between data tasks is configured. Specific operations of S11 may include S111 to S114.

In S111, data tasks are acquired.

Specifically, the operator may input data tasks through input devices such as a keyboard, a mouse, a touch screen, and a button according to an application scene of the method for data task scheduling, thereby acquiring the data tasks. Alternatively, historical data tasks may be acquired according to the application scene of the method for data task scheduling, to serve as the data tasks. After the data tasks are acquired, task relationships of the acquired data tasks may be configured according to task relationships between the historical data tasks, or the task relationships between the acquired data tasks may be configured according to a preset rule. Configuration of the task relationship between the data tasks is not limited to these manners, and the relationship between the data tasks may be configured in any manner well known to those skilled in the art. Configuration of the task relationship between the data tasks may include configuration of forward dependency, a priority, and an execution cycle of a data task in S112 to S114. Of course, in another embodiment, another task relationship may also be configured as required by the application scene.

In S112, forward dependency is configured for each of the data task.

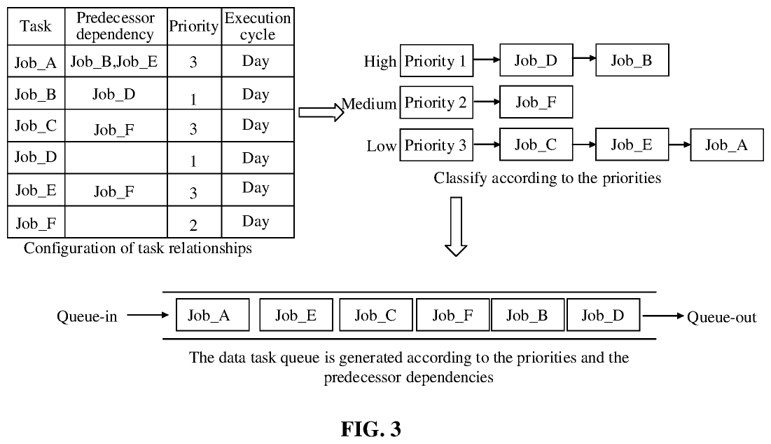

Specifically, the forward dependency of a data task refers to that the data task may be executed only if a certain data task is completed. For example, FIG. 3 illustrates forward dependencies of data tasks Job_A to Job_F. Referring to FIG. 3, the forward dependency of data task Job_A is data tasks Job_B and Job_E, namely, data task Job_A can executed only after data tasks Job_B and Job_E are executed. The forward dependency of data task Job_B is data task Job_D. Namely, Job_B can only be executed after Job_D is executed. The forward dependencies of data tasks Job_C to Job_F may refer to FIG. 3, and will not be elaborated herein. In the embodiment, forward dependency of a data task may be configured according to historical forward dependency of the data task or a preset rule. The forward dependency of the data task may further be optimized gradually by machine learning or in other manners to make a finally configured forward dependency of the data task more and more accurate and reduce the misjudgment ratio.

In S113, a priority is configured for each of the data tasks.

Specifically, the execution priority of a data task may be configured according to the importance of the data task. A more important data task may have a higher priority. Still referring to FIG. 3, the priorities of the data tasks may be divided into priorities 1, 2, and 3, sequentially corresponding to a high priority, a medium priority, and a low priority. The execution sequence is: a data task corresponding to priority 1 first, then a data task corresponding to priority 2, and finally a data task corresponding to priority 3. In another embodiment, the priorities of the data tasks may also be divided into less than three levels or more than three levels.

In S114, an execution cycle is configured for each of the data tasks.

Specifically, the execution cycle of the data task may be set according to a feature of a service requirement. The execution cycle of the data task may be configured as a minute, an hour, a day, a week, a month, a year, or the like. When the data task to be executed at present includes multiple data tasks, the execution cycle of each data task may be configured to be the same. For example, referring to FIG. 3, data cycles of data tasks Job_A to Job_F are all configured as a day. In another embodiment, when the data task to be executed at present includes multiple data tasks, the execution cycle of each data task may be configured to be different or partially the same.

It is to be noted that the forward dependency, priority, and execution cycle shown in FIG. 3 are only examples and the disclosure is not limited thereto.

In an embodiment, that the data task to be executed at present satisfies the preset condition includes that a forward data task that the data task to be executed at present depends on has been completed and a condition of an execution cycle of the data task to be executed at present is satisfied.

As shown in FIG. 2, the operation in S13 that whether the data task to be executed at present satisfies the preset condition is determined may include the following specific operation. In S131, whether the forward data task that the data task to be executed at present depends on has been completed and the condition of the execution cycle of the data task to be executed at present is satisfied are determined.

In the embodiment, after scheduling of the data task is started, whether the forward data task that the data task to be executed at present depends on has been completed and whether the condition of the execution cycle of the data task to be executed at present is satisfied is determined when the data task to be executed at present is received. S14 is executed if the forward data task that the data task to be executed at present depends on has been completed and the condition of the execution cycle of the data task to be executed at present is satisfied. S14 is not executed if the forward data task that the data task to be executed at present depends on is not completed or the data task to be executed at present does not satisfy the condition of the execution cycle of the data task to be executed at present.

In an embodiment, the method for data task scheduling further includes the following operation that alarm information is output in response to that the data task to be executed at present does not satisfy the preset condition.

Exemplarily, reference may be made to FIG. 2. S17 may be executed to output the alarm information in response to that the forward data task that the data task to be executed at present depends on is not completed or the data task to be executed at present does not satisfy the condition of the cycle of the data task to be executed at present.

Specifically, the alarm information may be output by sending an email, a short message or the like. In another embodiment, the alarm information may also be output in form of lamp flickering, voice, etc. In the embodiment, the output alarm information may represent that scheduling of the data task is exceptional.

In an embodiment, as shown in FIG. 2, the operation in S14 that the data task to be executed at present is ranked according to the task relationship to create the data task queue may include the following specific operations.

In S141, each data task to be executed at present is classified according to a respective priority.

Specifically, still referring to FIG. 3, data tasks Job_A to Job_F, for example, are classified according to priorities of the data tasks. The data tasks corresponding to priority 1 include Job_B and Job_D, the data task corresponding to priority 2 includes Job_F, and the data tasks corresponding to priority 3 include Job_A, Job_C, and Job_E.

In S142, the data task to be executed at present is ranked according to forward dependency of the data task to be executed at present corresponding to each priority, to create the data task queue.

Specifically, still taking FIG. 3 as an example, data tasks Job_A to Job_F to be executed at present are ranked according to the forward dependencies of the data tasks Job_A to Job_F to be executed at present corresponding to each priority to create the data task queue. Reference is made to the forward dependencies of data tasks Job_A to Job_F. In priority 1, since the forward data task that the data task Job_B depends on is Job_D, data task Job_D is ranked before data task Job_B. In priority 3, since data task Job_E is the forward data task that the data task Job_A depends on, and data task Job_F is the forward data task that the data task Job_C and data task Job_E depend on, Job_C, Job_E, and Job_A are sequentially ranked in priority 3. Data tasks Job_A, Job_E, Job_C, Job_F, Job_B, and Job_E are sequentially arranged from the queue-in to queue-out of the created data task queue.

In an embodiment, as shown in FIG. 2, the operation S15 that the load situation of the multiple node servers is acquired to determine the target node server includes the following specific operations.

In S151, for each of the multiple node servers, a respective data value of an index is acquired.

Optionally, the index of the node server may include at least one of: a central processing unit (CPU) utilization rate, a memory utilization rate, an input/output (I/O) utilization rate, or a concurrency. The index of the node server may specifically be any one or combination of the CPU utilization rate, the memory utilization rate, the I/O utilization rate, and the concurrency.

Specifically, the acquired data value of the index of each node server is a present practical data value of the index of the node server. Referring to Table 1, if the index of the node server includes, for example, the CPU utilization rate, the memory utilization rate, the I/O utilization rate, and the concurrency, the acquired data value of the index of a certain node server includes the CPU utilization rate 60%, the memory utilization rate 45%, the I/O utilization rate 70%, and the concurrency 5.

TABLE 1

| | | | | Collected | | |
|---|---|---|---|---|---|---|
| | Initial | Based | | data value | Calculation | |
| Index | value | score | Weight | (example) | formula | Score |
| CPU | 100% | 10 | 0.3 | 60% | (Data | 1.8 |
| utilization | | | | | value/initial | |
| rate | | | | | value)*based | |
| | | | | | score*weight | |
| Memory | 100% | 10 | 0.2 | 45% | (Data | 0.9 |
| utilization | | | | | value/initial | |
| rate | | | | | value)*based | |
| | | | | | score*weight | |
| I/O | 100% | 10 | 0.3 | 70% | (Data | 2.1 |
| utilization | | | | | value/initial | |
| rate | | | | | value)*based | |
| | | | | | score*weight | |
| Concurrency | 20 | 10 | 0.2 | 5 | (Data | 0.5 |
| | | | | | value/initial | |
| | | | | | value)*based | |
| | | | | | score*weight | |

| | |
|---|---|
| Total score | 5.3 |

In S152, a score of each node server is obtained according to the respective data value of the index.

Specifically, the score of each node server may be calculated according to a cluster load algorithm.

Optionally, the score of the node server is equal to

$${\sum }_{i = 1}^{i = n} ( ( \frac{Pi}{Yi} ) * Q * Mi ) .$$

Herein, i is a positive integer, n is a number of indexes, Pi is a data value of an i^{th} index, Yi is an initial value of the i^{th} index, Q is a based score, and Mi is a weight of the i^{th} index.

Still referring to Table 1, a score of the CPU utilization rate is equal to (acquired present practical data value of the CPU utilization rate/initial value of the CPU utilization rate)*based score*weight of the CPU utilization rate, and the data is substituted into the formula to obtain (60%/100%)*10*0.3=1.8 as the score of the CPU utilization rate. A score of the memory utilization rate is equal to (acquired present practical data value of the memory utilization rate/initial value of the memory utilization rate)*based score*weight of the memory utilization rate, and the data is substituted into the formula to obtain (45%/100%)*10*0.2=0.9 as the score of the memory utilization rate. A score of the I/O utilization rate is equal to (acquired present practical data value of the I/O utilization rate/initial value of the I/O utilization rate)*based score*weight of the I/O utilization rate, and the data is substituted into the formula to obtain (70%/100%)*10*0.3=2.1 as the score of the I/O utilization rate. A score of the concurrency is equal to (acquired present practical data value of the concurrency/initial value of the concurrency)*based score*weight of the concurrency, and the data is substituted into the formula to obtain (5/20)*10*0.2=0.5 as the score of the concurrency. The score of the node server is a sum of the score of the CPU utilization rate, the score of the memory utilization rate, the score of the I/O utilization rate, and the score of the concurrency, and the data is substituted into the formula to obtain 1.8+0.9+2.1+0.5=5.3 as the score of the node server.

In an embodiment, a node server having a score lower than a set threshold is determined as the target node server.

Specifically, in S16, based on the data task queue, the data task to be executed at present is sent to the node server with a score lower than the set threshold, for processing. For example, still referring to Table 1, the based score of the node server is 10. The set threshold may be configured to 8. When the score of the node server is more than or equal to 8, it indicates that the node server is loaded heavily and is unsuitable to be distributed with any data task. When the score of the node server is lower than 8, it indicates that the node server is not so heavily loaded, and the data task to be executed at present is distributed to the node server for processing, based on the data task queue.

Optionally, in response to that there are multiple node servers each having a score lower than the set threshold, a node server with a lowest score is determined as the target node server.

In an embodiment, as shown in FIG. 2, the operation in S16 that the data task to be executed at present is sent, based on the data task queue, to the target node server for processing includes the following specific operation.

In S161, the data task to be executed at present is directly sent to the target node server for processing based on the data task queue; or database cleaning is performed on the data task to be executed at present to obtain a format required by the target node server, the data task of the format is sent to the target node server for processing.

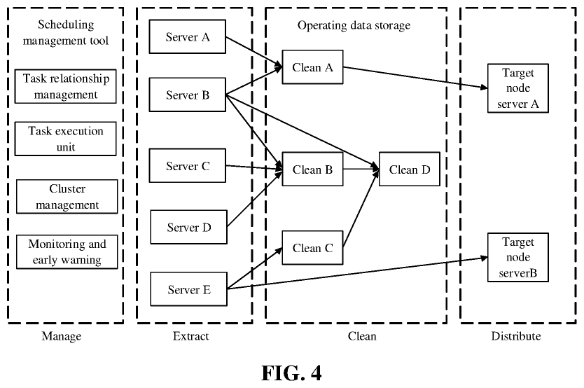

Specifically, it may be set according to the service requirement that the data task to be executed at present is directly sent to the target node server according to the data task queue. Referring to FIG. 4, after a data task queue is created for data tasks in an extraction server E, a data task to be executed at present is directly sent to target node server B based on the data task queue. For example, the target node server is a server used by an employee of an enterprise, a department management server or the like. Database cleaning is not required in case of distribution to a system server for verification in system login. Alternatively, it may also be set according to the service requirement that database cleaning is performed on the data task to be executed at present to obtain the format required by the target node server, and the data task of the required format is sent to the target node server for processing based on the data task queue. Referring to FIG. 4, the data task queue is created for the data tasks in extraction server A, and then the data task to be executed at present is cleaned and sent to target server A based on the data task queue. For example, the target node server cannot use received machine table data directly, and instead, the data may be sent to the node server for processing after subjecting to database cleaning to generate the format required by the target node server.

In an embodiment, as shown in FIG. 2, the method for data task scheduling further includes the following operation. In S18, the multiple node servers are maintained. S181, and/or S182 to S184 may specifically be included.

In S181, a node server is added, deleted, or modified.

Specifically, multiple node server components may be configured as a cluster for intelligent data scheduling management, and node servers may be added, deleted, or modified in a cluster management module. Alternatively, the cluster management module may monitor whether the present state of the node server is normal, busy, or exceptional and check the load situation of the node server such as the CPU utilization rate, the memory utilization rate, the I/O utilization rate, a network.

In S182, whether one of the multiple node servers is exceptional is determined.

Specifically, whether the node server is in normal network connection, whether the CPU utilization rate, the memory utilization rate, and the I/O utilization rate are too high, etc., may be determined. S183 is executed if it is determined that the node server is exceptional.

In S183, alarm information is output.

Specifically, the alarm information indicating that the node server is exceptional may be output in form of a short message, an email, etc. In another embodiment, the alarm information indicating that the node server is exceptional may also be output in form of light, voice, etc. An exceptional node server may not be determined as the target node server in S16, namely the data task queue may not be sent to the exceptional node server for processing. Therefore, the situation that the data task cannot be executed is avoided.

According to the method for data task scheduling, whether the data task to be executed at present satisfies the preset condition may be recognized automatically according to the configured task relationship, and the load situation of each node server is analyzed for scheduling in cluster management, thereby providing efficient data distribution and execution functions and improving the scheduling speed and the load capacity of each node server. Therefore, increasing service requirements are met, the problem of poor scheduling capability is solved, and intelligent data scheduling management reaches the enterprise-level requirement.

It is to be understood that, although actions in the flowcharts of FIG. 1 to 2 are sequentially presented as indicated by the arrows, these actions are not necessarily executed according to the sequences indicated by the arrows. Unless otherwise clearly described in the disclosure, there is no strict limitation to execution sequences of these actions and these actions may be executed in other sequences. Moreover, at least some of actions in FIGS. 1 to 2 may include multiple sub-actions or stages which are not necessarily executed or completed simultaneously but may be executed at different moments, and which are not necessarily executed sequentially but may be executed in turn or alternately with other actions or sub-actions or stages thereof.

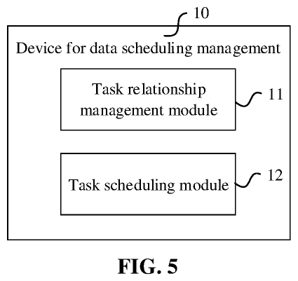

In an embodiment, as illustrated in FIG. 5, there is provided a device 10 for data task scheduling, which includes a task relationship management module 11 and a task scheduling module 12.

The task relationship management module 11 is configured to: acquire a data task to be executed at present which is configured with a task relationship, and determine whether the data task to be executed at present satisfies a preset condition.

The task scheduling module 12 is configured to: in response to that the data task to be executed at present satisfies the preset condition, receive the data task to be executed at present, rank the data task to be executed at present according to the task relationship to create a data task queue, acquire a load situation of a plurality of node servers to determine a target node server, and send, based on the data task queue, the data task to be executed at present to the target node server for processing.

In the device 10 for data task scheduling, each data task is configured with a corresponding task relationship. That is to say, there is also a corresponding task relationship for the data task to be executed at present. The data task to be executed at present is ranked according to the task relationship to create the data task queue, in response to that the data task to be executed at present satisfies the preset condition, so that relationships between data tasks to be executed at present can be figured out automatically even if complex. The execution efficiency of the data tasks is improved effectively, data quality problems caused by manual intervention are solved, and the integrity of data is ensured. Moreover, the target node server is determined according to the load situation of each node server, and the data task to be executed at present is sent to the target node server for processing based on the data task queue. The case that some node servers are affected in terms of processing speed and even cannot perform processing due to excessive load and resources are wasted due to relatively low load of some node servers may be avoided. The load of all node servers is relatively balanced, and data tasks in complex relationships may also be distributed and executed well. According to the device 10 for data task scheduling, a scheduling tool may bear more scheduled tasks, shorten the task execution time and achieve a scaling-out capability.

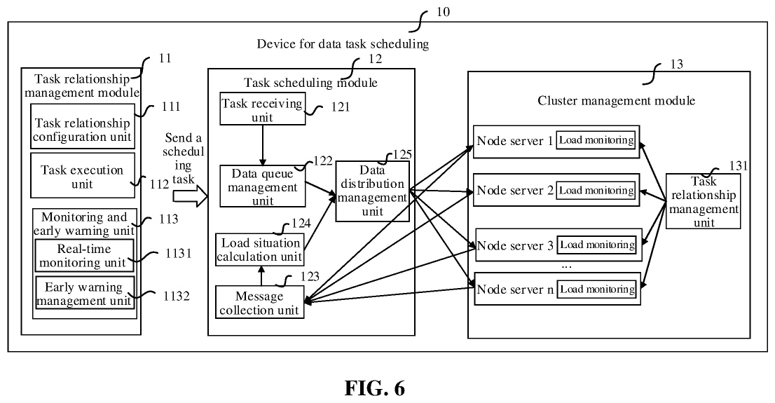

In an embodiment, as illustrated in FIG. 6, the device 10 for data task scheduling further includes a cluster management module 13. The cluster management module 13 is in communication connection with the multiple node servers and configured to maintain the multiple node servers. The cluster management module 13 may include a cluster management unit 131. Specifically, the cluster management module 131 may be in communication connection with the multiple node servers and configured to maintain the multiple node servers. The operation that the multiple node servers are maintained includes at least one of the following operations: a node server is added, deleted, or modified; or whether one of the node servers is exceptional is determined, and alarm information is output in response to that the node server is exceptional.

In an embodiment, referring to FIG. 6, the task relationship management module 11 includes a task relationship configuration unit 111 and a task execution unit 112. The task relationship configuration unit 111 is configured to acquire data tasks, configure forward dependency of each of the data tasks, configure a priority for each of the data tasks, and configure an execution cycle for each of the data tasks. The priority of the data task represents an execution sequence of the data task. The task execution unit 112 may be configured to acquire the data task to be executed at present and execute a scheduling task such as starting, stopping, and restarting on the data task to be executed at present. Specifically, the scheduling task may be output to the task scheduling module 12 when it is determined that the data task to be executed at present satisfies the preset condition. In another embodiment, the task relationship management module 11 may further include a monitoring and early warning unit 113. The monitoring and early warning unit 113 may specifically include a real-time monitoring unit 1131 and an early warning management unit 1132. The real-time monitoring unit 1131 is configured to determine whether the data task to be executed at present satisfies the preset condition. If NOT, the early warning management unit 1132 outputs alarm information.

Optionally, that the data task to be executed at present satisfies the preset condition includes that a forward data task that the data task to be executed at present depends on has been completed and a condition of an execution cycle of the data task to be executed at present is satisfied.

In an embodiment, referring to FIG. 6, the task scheduling module 12 includes a task receiving unit 121, a data queue management unit 122, a load situation calculation unit 124, a message collection unit 123, and a data distribution management unit 125.

The task receiving unit 121 is configured to receive the scheduling task sent by the task relationship management module 11, namely configured to receive the data task to be executed at present sent by the task relationship management module 11.

The data queue management unit 122 is configured to classify each data task to be executed at present according to a respective priority and rank the data task to be executed at present according to forward dependency of the data task to be executed at present corresponding to each priority class, to create the data task queue.

The message collection unit 123 is configured to acquire a respective data value of an index for each of the multiple node servers.

The load situation calculation unit 124 is configured to obtain a score of each node server according to the respective data value of the index, to determine the target node server.

The data distribution management unit 125 is configured to send, based on the data queue, the data task to be executed at present to the target node server for processing.

In an embodiment, a node server having a score lower than a set threshold is determined as the target node server.

In an embodiment, in response to that there are multiple node servers each having a score lower than the set threshold, a node server with a lowest score is determined as the target node server.

In an embodiment, the index includes at least one of: a CPU utilization rate, a memory utilization rate, an I/O utilization rate, or a concurrency.

In an embodiment, the score is equal to

$${\sum }_{i = 1}^{i = n} ( ( \frac{Pi}{Yi} ) * Q * Mi ) .$$

Herein, i is a positive integer, n is the number of indexes, Pi is a data value of an i^{th} index, Yi is an initial value of the i^{th} index, Q is a based score, and Mi is a weight of the i^{th} index.

In an embodiment, the data distribution management unit 125 may directly send, based on the data task queue, the data task to be executed at present to the target node server for processing; or perform database cleaning on the data task to be executed at present to obtain a format required by the target node server, and send the data task of the format to the target node server for processing.

Particular limitation of the device 10 for data task scheduling may refer to the above limitations of the method for data task scheduling, and will not be elaborated here. The modules in the device 10 for data task scheduling may completely or partially be implemented by software, hardware, and a combination thereof. Each module may be embedded in a hardware form into a processor in computer device or may be independent therefrom, or may be stored in a software form in a memory in the computer device, for the processor to call to execute the operations corresponding to each module.

There is provided in an embodiment a scheduling tool including a memory and a processor. A computer program is stored in the memory. The processor executes the computer program to implement the actions in each method embodiment above.

There is provided in an embodiment a computer-readable storage medium having stored thereon a computer program which, when executed by a processor, implements the actions in each method embodiment above.

It can be understood by those of ordinary skill in the art that all or part of the flows in the method of the abovementioned embodiments may be completed by instructing related hardware through a computer program which may be stored in a non-volatile computer-readable storage medium. When the computer program is executed, the flows of each method embodiment may be included. Any memory, storage, database, or other medium used by reference in each embodiment provided in the disclosure may include at least one of a non-volatile or volatile memory. The non-volatile memory may include a Read-Only Memory (ROM), a magnetic tape, a floppy disk, a flash memory, an optical memory, or the like. The volatile memory may include a Random Access Memory (RAM) or an external high-speed buffer memory. As explanation rather than restriction, the RAM may be in various forms, such as a Static RAM (SRAM) or a Dynamic RAM (DRAM).

Technical features of the abovementioned embodiments may be combined freely. For conciseness of description, not all possible combinations of technical features in the abovementioned embodiments are described. However, any combination of these technical features shall fall within the scope of the specification without conflict.

The abovementioned embodiments only express some implementations of the disclosure and are specifically described in detail, but shall not be understood as limitation to the patent scope of the disclosure. It is to be pointed out that those of ordinary skill in the art may further make transformations and improvements without departing from the concept of the disclosure and all these fall within the scope of protection of the application. Therefore, the scope of patent protection o should be salient object to the appended claims.

1. A method for data task scheduling, comprising:
acquiring a data task to be executed at present which is configured with a task relationship;
in response to that the data task to be executed at present satisfies a preset condition, ranking, according to the task relationship, the data task to be executed at present to create a data task queue;
acquiring a load situation of a plurality of node servers, to determine a target node server; and
sending, based on the data task queue, the data task to be executed at present to the target node server for processing.

2. The method for data task scheduling of claim 1, further comprising: before acquiring the data task to be executed at present,
acquiring data tasks;
configuring forward dependency for each of the data tasks;
configuring a priority for each of the data tasks, the priority representing an execution sequence of the data task; and
configuring an execution cycle for each of the data tasks.

3. The method for data task scheduling of claim 2, wherein that the data task to be executed at present satisfies the preset condition comprises that:
a forward data task that the data task to be executed at present depends on has been completed and a condition of an execution cycle of the data task to be executed at present is satisfied.

4. The method for data task scheduling of claim 2, wherein ranking, according to the task relationship, the data task to be executed at present to create the data task queue comprises:
classifying each data task to be executed at present according to a respective priority; and
ranking the data task to be executed at present according to forward dependency of the data task to be executed at present corresponding to each priority, to create the data task queue.

5. The method for data task scheduling of claim 1, wherein acquiring the load situation of the plurality of node servers to determine the target node server comprises:
for each of the plurality of node servers, acquiring a respective data value of an index; and
obtaining a score of each node server according to the respective data value of the index, to determine the target node server.

6. The method for data task scheduling of claim 5, further comprising: determining a node server having a score lower than a set threshold as the target node server.

7. The method for data task scheduling of claim 6, further comprising: in response to that there are a plurality of node servers each having a score lower than the set threshold, determining a node server with a lowest score as the target node server.

8. The method for data task scheduling of claim 5, wherein the index comprises at least one of:
a central processing unit (CPU) utilization rate,
a memory utilization rate,
an input/output (IO) utilization rate, or
a concurrency.

9. The method for data task scheduling of claim 5, wherein the score is equal to
$${\sum }_{i = 1}^{i = n} ( ( \frac{Pi}{Yi} ) * Q * Mi ) ,$$
where i is a positive integer, n is a number of indexes, Pi is a data value of an i^{th} index, Yi is an initial value of the i^{th} index, Q is a based score, and Mi is a weight of the i^{th} index.

10. The method for data task scheduling of claim 1, wherein sending, based on the data task queue, the data task to be executed at present to the target node server for processing comprises:
directly sending, based on the data task queue, the data task to be executed at present to the target node server for processing; or
performing database cleaning on the data task to be executed at present to obtain a format required by the target node server, and sending the data task of the format to the target node server for processing.

11. The method for data task scheduling of claim 1, further comprising:
outputting alarm information in response to that the data task to be executed at present does not satisfy the preset condition.

12. The method for data task scheduling of claim 1, further comprising: maintaining the plurality of node servers, wherein maintaining the plurality of node servers comprises at least one of:
adding, deleting, or modifying a node server; or
determining whether one of the plurality of node servers is exceptional, and outputting alarm information in response to that the node server is exceptional.

13. A scheduling tool, comprising a memory and a processor, wherein the memory stores a computer program capable of running in the processor, and the processor is configured to execute the computer program to implement following:
acquiring a data task to be executed at present which is configured with a task relationship;
in response to that the data task to be executed at present satisfies a preset condition, ranking, according to the task relationship, the data task to be executed at present to create a data task queue;
acquiring a load situation of a plurality of node servers, to determine a target node server; and
sending, based on the data task queue, the data task to be executed at present to the target node server for processing.

14. The scheduling tool of claim 13, before acquiring the data task to be executed at present, the processor is further configured to execute the computer program to implement following:
acquiring data tasks;
configuring forward dependency for each of the data tasks;
configuring a priority for each of the data tasks, the priority representing an execution sequence of the data task; and
configuring an execution cycle for each of the data tasks.

15. The scheduling tool of claim 13, wherein in acquiring the load situation of the plurality of node servers to determine the target node server, the processor is configured to execute the computer program to implement following:
for each of the plurality of node servers, acquiring a respective data value of an index; and
obtaining a score of each node server according to the respective data value of the index, to determine the target node server.

16. The scheduling tool of claim 15, wherein the processor is further configured to execute the computer program to implement following:
determining a node server having a score lower than a set threshold as the target node server.

17. The scheduling tool of claim 17, wherein the processor is further configured to execute the computer program to implement following:
in response to that there are a plurality of node servers each having a score lower than the set threshold, determining a node server with a lowest score as the target node server.

18. The scheduling tool of claim 13, wherein in sending, based on the data task queue, the data task to be executed at present to the target node server for processing, the processor is configured to execute the computer program to implement following:
directly sending, based on the data task queue, the data task to be executed at present to the target node server for processing; or
performing database cleaning on the data task to be executed at present to obtain a format required by the target node server, and sending the data task of the format to the target node server for processing.

19. The scheduling tool of claim 13, wherein the processor is further configured to execute the computer program to implement: maintaining the plurality of node servers, wherein in maintaining the plurality of node servers, the processor is configured to execute the computer program to implement at least one of:
adding, deleting, or modifying a node server; or
determining whether one of the plurality of node servers is exceptional, and outputting alarm information in response to that the node server is exceptional.

20. A non-transitory computer-readable storage medium having stored thereon a computer program which, when executed by a processor, implements following:
acquiring a data task to be executed at present which is configured with a task relationship;
in response to that the data task to be executed at present satisfies a preset condition, ranking, according to the task relationship, the data task to be executed at present to create a data task queue;
acquiring a load situation of a plurality of node servers, to determine a target node server; and
sending, based on the data task queue, the data task to be executed at present to the target node server for processing.
